(19) United States
(12) Patent Application Publication
(10) Pub. No.: US 2011/0111250 A1
(43) Pub. Date: May 12, 2011

(54) PROCESS FOR PRODUCING A FOAMED METAL ARTICLE

(76) Inventor: Ken Evans, Brampton (CA)

(21) Appl. No.: 12/761,391

(22) Filed: Apr. 16, 2010

Related U.S. Application Data
(60) Provisional application No. 61/259,963, filed on Nov. 10, 2009.

(51) Int. Cl. C22C 21/02; B22F 3/11; B32B 5/20

(52) U.S. Cl. 428/613; 419/2; 420/548

(57) ABSTRACT

A process for producing a foamed metal article comprises the steps of combining together at least one metal powder, silicon powder a gas-producing blowing agent including hydrated magnesium silicate powder, and graphite to form a mixture; compacting the mixture into a foamable metal precursor; placing the foamable metal precursor in a carrier; and heating the foamable metal precursor in the carrier to at least a predetermined temperature for at least a predetermined amount of time, to thereby cause the foamable metal precursor to foam, thus producing a foamed metal article.

This application is a non-provisional application claiming priority to U.S. Provisional Patent Application Ser. No. 61/259,963 filed on Nov. 10, 2009.

### FIELD OF THE INVENTION

The present invention relates to a process for foamable metals and more particularly to mixtures of foamable metal metals produced from at least one metal powder and a gas-producing blowing agent.

### BRIEF DESCRIPTION OF THE DRAWINGS

The novel features which are believed to be characteristic of the process for producing a foamed metal article and process for producing a foamable metal precursor according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a cross-sectional side elevational view of a foamed metal article produced in accordance with prior art techniques;

FIG. 2 is a block diagrammatic view of the process for producing a foamed metal article and process for producing a foamable metal precursor according to a preferred embodiment of the present invention;

FIG. 3 is a first cross-sectional side elevational view of a foamed metal article produced by the preferred embodiment of the process according to the present invention; and

FIG. 4 is a second cross-sectional side elevational view of a foamed metal article produced by the preferred embodiment of the process according to the present invention.

### BACKGROUND OF THE INVENTION

The production of foamed metal articles is well known in the art. There are various of patents and publications concerning the production of foamed metal articles, devices and processes for producing said articles, and the metal/foaming agent mixtures used therein. There are many applications for foamed metals, including, but not limited to, stiffening of hollow structures, sound and vibration dampening, inhibition of energy flows, and creation of decorative elements.

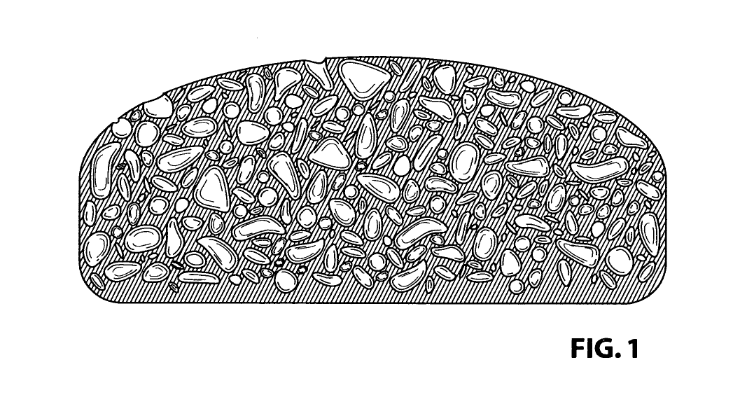

An example of an aluminum foamed metal article produced using prior art techniques is shown in FIG. 1. The process for producing such an aluminum foamed metal article 26 includes using 1% titanium hydride as the gas-producing blowing agent. It has been found that there are two very significant problems with this prior art process. First, the cost of titanium hydride is high enough to prohibit the use of titanium hydride as a gas-producing blowing agent. Accordingly, many products that could be produced from foamed metal are not readily marketable if titanium hydride is used.

Secondly, foamed metal articles produced using titanium hydride in accordance with known prior art processes show extensive compaction (i.e., a substantial layer of unfoamed material) of the base zone along the bottom of the article (see FIG. 1). The cell distribution in the foamed structure is very irregular, and the cells themselves are mainly coarse, and some have risen. This results in a somewhat fissured surface of the metal article, where large gas bubbles of this openings in the “windows” of the gas bubbles frequently appear to be fissured. In addition, this prior art process usually results in a substantial amount of unfoamed metal material at the base of the foamed metal article.

One prior art patent that discloses such a process is U.S. Pat. No. 5,972,285 issued Oct. 26, 1999 to Knott, and entitled Foamable Metal Articles. This patent teaches a process for producing foamable material articles, to the compacted semifinished product obtainable in this way, to the use of the semifinished product for foaming a closed-cell metal article, and to the closed-cell metal articles obtained in this way. The mixtures of the foamable metal articles are produced from at least one metal powder and one gas-producing blowing agent and compacted to a semifinished product, wherein a gas-producing blowing agent comprising magnesium hydride is employed.

Accordingly, there is a need in the art for an improved metal/foaming agent mixture and process for the production of foamed metal articles, that is less expensive and results in more thorough and consistent cell formation in the foamed metal article.

It is an object of the present invention to provide a process for producing a foamed metal article.

It is an object of the present invention to provide a process for producing a foamed metal article, which process is relatively inexpensive.

It is an object of the present invention to provide a process for producing a foamed metal article, which process results in thorough and consistent cell formation in the foamed metal articles produced.

### SUMMARY OF THE INVENTION

This invention is directed to an improved process for producing foamable and foamed metal articles, and an improvement of the industrial properties of the foamable products and of the closed-cell foamed metal articles by comparison with the prior art.

In accordance with one aspect of the present invention there is disclosed a novel process for producing a foamed metal article. The process comprises the steps of combining together at least one metal powder, silicon powder and a gas-producing blowing agent including hydrated magnesium silicate powder to form a mixture; compacting the mixture into a foamable metal precursor; placing the foamable metal precursor in a carrier; and heating the foamable metal precursor in the carrier to at least a predetermined temperature for at least a predetermined amount of time, to thereby cause the foamable metal precursor to foam, thus producing a foamed metal article.

In accordance with another aspect of the present invention there is disclosed a novel process for producing a foamable metal precursor to be used for producing a foamed metal article. The process comprises the steps of combining together at least one metal powder, silicon powder and a gas-producing blowing agent including hydrated magnesium silicate powder to form a mixture; and compacting the mixture into a foamable metal precursor.

In accordance with yet another aspect of the present invention there is disclosed a novel foamed metal article produced by a process comprising the steps of combining together at least one metal powder, silicon powder and a gas-producing blowing agent including hydrated magnesium silicate powder to form a mixture; compacting the mixture into a foamable metal precursor; placing the foamable metal precursor in a mould; and heating the foamable metal precursor in the mould to at least a predetermined temperature for at least a predetermined amount of time, to thereby cause the foamable metal precursor to foam, thus producing a foamed metal article.

In accordance with yet another aspect of the present invention there is disclosed a novel foamable metal precursor produced by a process comprising the steps of combining together at least one metal powder, silicon powder and a gas-producing blowing agent including hydrated magnesium silicate powder to form a mixture; and compacting the mixture into a foamable metal precursor.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### DETAILED DESCRIPTION OF A PREFERRED EMBODIMENT

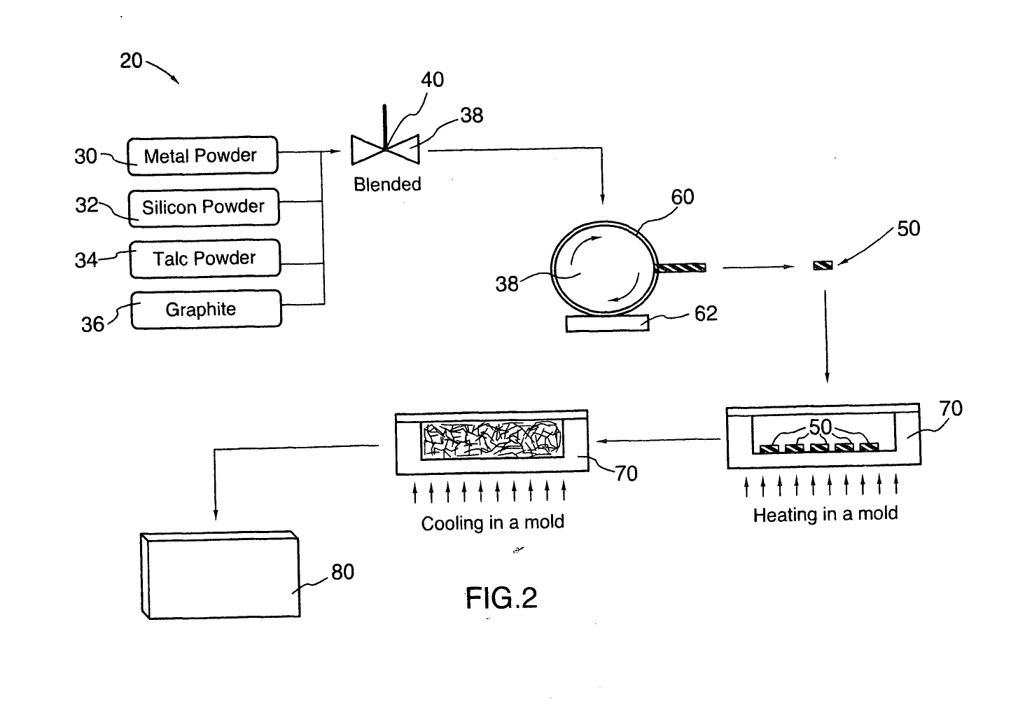

Referring to FIGS. 2 through 4 of the drawings, it will be noted that FIGS. 2 through 4 illustrate a preferred embodiment of the process for producing a foamed metal article and process for producing a foamable metal precursor according to the present invention, as indicated by the general reference numeral 20.

It is possible to foam all fusible metals or metal alloys in accordance with the method described herein. In one exemplary embodiment, the metal powder 30 particularly preferably employed for the purpose of the present invention is aluminum and its alloys. In this embodiment, the metal powder 30 comprises essentially aluminum, and where appropriate, conventional alloying constituents including, but not limited to, magnesium, copper, and/or silicon.

Reference will now be made to FIGS. 2 through 4, which show the process for producing a foamed metal article and the process for producing a foamable metal precursor.

Reference will now specifically be made to FIG. 2 which shows the overall process 20 according to the present invention. The process 20 comprises as a first step, combining together at least one metal powder 30, which in this embodiment is aluminum powder 30, silicon powder 32 and a gas-producing blowing agent 34 that includes hydrated magnesium silicate powder, to form a mixture 38. The preferable manner in which the various materials are combined together is by blending in a suitable industrial blender 40. The blender 40 may be a continuous feed blender or may be an intermittent feed blender.

Unexpectedly, it has been found that hydrated magnesium silicate powder [H₂Mg₃(SiO₃)₄], [Mg₃Si₄O₁₀(OH)₂], also known by its more common name of talc powder, performs the function of a gas-producing blowing agent 34 at a fraction of the cost of previously know prior art gas-producing blowing agents.

In the preferred embodiment, as illustrated, the at least one metal powder 30 comprises aluminum powder. Alternatively, any other suitable metal powder 30 could be used, or suitable mixtures of metal powders could be used.

It has also been found that it is completely acceptable for the gas-producing blowing agent 34 to comprise mostly hydrated magnesium silicate powder, and even to comprise only hydrated magnesium silicate powder, and produce excellent results. The low cost and ready availability of hydrated magnesium silicate powder makes it particularly desirable as a gas-producing blowing agent.

The next step in the process is compacting the mixture 38 into a foamable metal precursor 50 that will subsequently be used to produce a foamed metal article. This step is usually best done by also including the step of applying heat during the step of compacting the mixture 38 into a foamable metal precursor 50. The step of compacting may be carried out using an extruder 60 or any other suitable type of equipment. The step of applying heat is preferably done by means of a suitable heating apparatus or element 62 within the extruder or other equipment.

The step of compacting the mixture 38 into a foamable metal precursor is preferably carried out below the decomposition temperature of hydrated magnesium silicate powder in order to preserve the hydrated magnesium silicate powder for a subsequent step in the process. The mixture 38 is compacted to a density of at least 90 percent of the theoretical density of the metal in the metal powder, and most preferably about 98 percent of the theoretical density of the metal in the metal powder 30; however, it has been found that compacting the mixture 38 to a density of 98 percent of the theoretical density of the metal powder 30 is very difficult.

The next step is placing the foamable metal precursor 50 in a carrier 70, such as a tray, an open mould or a closed mould (as shown in the preferred embodiment. If the foamable metal precursor 50 is placed in a tray, during subsequent processing, the foamable metal precursor will form to a generally random shape. If the foamable metal precursor is placed in a closed mold, during subsequent processing, the foamable metal precursor will form to the shape of the enclosed mould. Any suitable shape of mould can be used, thus allowing many various shapes to be formed.

The final step is heating the foamable metal precursor in the carrier to at least a predetermined temperature for at least a predetermined amount of time, to thereby cause the foamable metal precursor 50 to foam, thus producing a foamed metal article 80. Typically, the foamed metal article 80 is also cooled in the same carrier for the sake of convenience, safety and product integrity.

In the preferred embodiment as illustrated, the present method preferably, but not necessarily, further comprises the step of including graphite 36 along with the mixture 38. The step of including graphite 36 along with the mixture 38 is best done by mixing the graphite 36 into the mixture 38 so that it is evenly distributed with the other components of the mixture 38. If there is graphite 36 in the mixture 38, the at least one metal powder 30 should comprise about eighty-eight percent (88%) of the mixture 38, the silicon powder 32 comprises about ten percent (10%) of the mixture 38, the gas-producing blowing agent 34 comprises about one percent (1%) of the mixture 38, and the graphite 36 comprises about one percent (1%) of the mixture 38. It has been found that the graphite 36 allows the mixture 38 to be moved through the extruder much more quickly, thus significantly cutting the overall processing, and therefore reducing manufacturing costs.

In the event that the graphite powder 36 is not used, the aluminum powder 30 comprises about eighty-nine percent (89%) of the mixture 38, the silicon powder 32 comprises about ten percent (10%) of the mixture 38, and the gas-producing blowing agent 34 comprises about one percent (1%) of the mixture 38.

It has been found that with the silicon powder 32 comprising between about eight percent (8%) and about twelve percent (12%) of the mixture 38, and the gas-producing blowing agent 34 comprising between about eight-tenths percent (0.8%) and about one and two-tenths percent (1.2%) of the mixture 38 works well, with or without graphite. Preferably, the ratio of the silicon powder 32 to the hydrated magnesium silicate powder is about 10:1.

In another aspect of the present invention, there is disclosed a process for producing a foamable metal precursor 50 to be used for producing a foamed metal article 80. The process is a subset of the above described process for process for producing a foamed metal article 80 and comprises as a first step combining together at least one metal powder 30, silicon powder 32 and a gas-producing blowing agent 34 including hydrated magnesium silicate powder to form a mixture 38. The second step is compacting the mixture 38 into a foamable metal precursor 50. The remaining steps and specifications related to those steps, as set forth above, apply to the process for producing a foamable metal precursor 50.

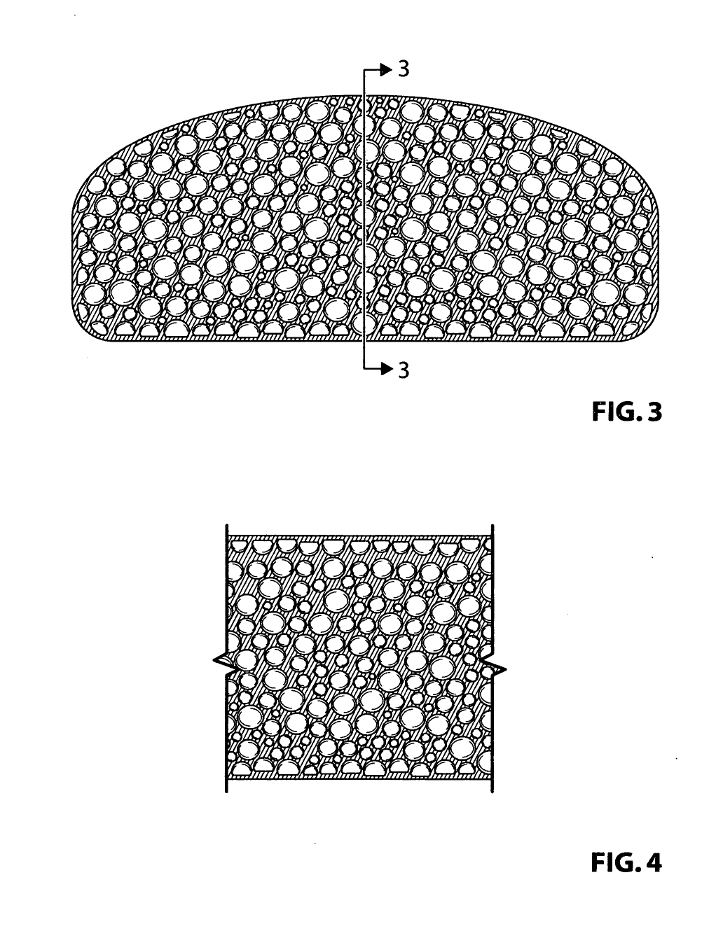

FIGS. 3 and 4 show a cross-section of a representative foamed metal article 80, cut transversely.

The foamed metal article 80 produced with the aid of the gas-producing blowing agent 34 in accordance with the present invention, especially produced auto-catalytically, have a morphology differing from that of foams obtained using prior art foaming agents (for example, titanium hydride). The foamed metal articles obtained by means of the process described herein have a very homogenous pore density distribution extending into the surface regions of the shaped foamed metal article 80, as seen in FIGS. 3 and 4. FIGS. 3 and 4 show an aluminum foamed product produced according to the present invention using 10% silicon powder 32 and 1% talc powder 34 as the gas-producing blowing agent, and aluminum metal powder 30 (percentages are by weight of the blended mixture 38). This represents a considerable advance over foamed metal articles formed using prior art methods and prior art gas-producing blowing agents.

In contrast to the prior art, the foamed article produced in accordance with the present invention (shown in FIGS. 3 and 4) distinctly shows more uniform foaming. The compacted base zone in this article 70 is only approximately 0.25 mm thick, a marked improvement over the up to 10 mm thick base zone 30 shown in the prior art material (FIG. 1). In addition, the number of cells per unit volume in the foamed metal article 80 produced in accordance with the present invention is distinctly greater, specifically with preference for the presence of small cells 82. Irregularity of cells is distinctly less pronounced than in the prior-art article, and the openings are finer and more uniform.

As seen in FIGS. 3 and 4, the openings in the “windows” of the gas bubbles do not appear to be fissured in the metal foam of the present invention. This indicates that, at the time when the volume of the metal changed, the viscosity of the material foamed according to the prior art is less than that of the material foamed according to the invention.

As can be understood from the above description and from the accompanying drawings, the present invention provides a process for producing a foamed metal article and process for producing a foamable metal precursor, all of which features are unknown in the prior art.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Other variations of the above principles will be apparent to those who are knowledgeable in the field of the invention, and such variations are considered to be within the scope of the present invention. Further, other modifications and alterations may be used in the design and manufacture of the present invention without departing from the spirit and scope of the accompanying claims. Accordingly, it is intended that the scope of the invention be defined by the claims appended hereto.

I claim:

1. A process for producing a foamed metal article, said process comprising the steps of:
combining together at least one metal powder, silicon powder and a gas-producing blowing agent including hydrated magnesium silicate powder to form a mixture;
compacting said mixture into a foamable metal precursor;
placing the foamable metal precursor in a carrier; and,
heating the foamable metal precursor in said carrier to at least a predetermined temperature for at least a predetermined amount of time, to thereby cause said foamable metal precursor to foam, thus producing a foamed metal article.

2. The process of claim 1, wherein the step of heating the foamable metal precursor in a carrier comprises heating the foamable metal precursor in a mould.

3. The process of claim 2, wherein the step of heating the foamable metal precursor in a mould comprises heating the foamable metal precursor in a closed mould.

4. The process of claim 1, further comprising the step of applying heat during the step of compacting said mixture into a foamable metal precursor.

5. The process of claim 1, wherein said at least one metal powder comprises about eighty-nine percent (89%) of said mixture, said silicon powder comprises about ten percent (10%) of said mixture, and said gas-producing blowing agent comprises about one percent (1%) of said mixture.

6. The process of claim 1, wherein said silicon powder comprises between about eight percent (8%) and about twelve percent (12%) of said mixture.

7. The process of claim 1, wherein said gas-producing blowing agent comprises between about eight-tenths percent (0.8%) and about one and two-tenths percent (1.2%) of said mixture.

8. The process of claim 1, wherein the ratio of said silicon powder to said hydrated magnesium silicate powder is about 10:1.

9. The process of claim 1, wherein said gas-producing blowing agent comprises mostly hydrated magnesium silicate powder.

10. The process of claim 9, wherein said gas-producing blowing agent comprises only hydrated magnesium silicate powder.

11. The process of claim 1, wherein the step of compacting said mixture into a foamable metal precursor is carried out below the decomposition temperature of hydrated magnesium silicate powder.

12. The process of claim 1, wherein said mixture is compacted to a density of at least 90 percent of the theoretical density of the metal in the metal powder.

13. The process of claim 1, further comprising the step of including graphite along with said mixture.

14. The process of claim 13, wherein the step of including graphite along with said mixture comprises mixing said graphite into said mixture.

15. The process of claim 14, wherein said at least one metal powder comprises about eighty-nine percent (88%) of said mixture, said silicon powder comprises about ten percent (10%) of said mixture, said gas-producing blowing agent comprises about one percent (1%) of said mixture, and said graphite comprises about one percent (1%) of said mixture.

16. A process for producing a foamable metal precursor to be used for producing a foamed metal article, said process comprising the steps of:
combining together at least one metal powder, silicon powder and a gas-producing blowing agent including hydrated magnesium silicate powder to form a mixture; and,
compacting said mixture into a foamable metal precursor.

17. The process of claim 16, further comprising the step of applying heat during the step of compacting said mixture into a foamable metal precursor.

18. The process of claim 16, wherein said at least one metal powder comprises about eighty-nine percent (89%) of said mixture, said silicon powder comprises about ten percent (10%) of said mixture, and said gas-producing blowing agent comprises about one percent (1%) of said mixture.

19. The process of claim 16, wherein said silicon powder comprises between about eight percent (8%) and about twelve percent (12%) of said mixture.

20. The process of claim 16, wherein said gas-producing blowing agent comprises between about eight-tenths percent (0.8%) and about one and two-tenths percent (1.2%) of said mixture.

21. The process of claim 16, wherein the ratio of said silicon powder to said hydrated magnesium silicate powder is about 10:1.

22. The process of claim 16, wherein said gas-producing blowing agent comprises mostly hydrated magnesium silicate powder.

23. The process of claim 16, wherein said gas-producing blowing agent comprises only hydrated magnesium silicate powder.

24. The process of claim 16, wherein the step of compacting said mixture into a foamable metal precursor is carried out below the decomposition temperature of hydrated magnesium silicate powder.

25. The process of claim 16, wherein said mixture is compacted to a density of at least 90 percent of the theoretical density of the metal in the metal powder.

26. The process of claim 16, further comprising the step of including graphite along with said mixture.

27. The process of claim 26, wherein the step of including graphite along with said mixture comprises mixing said graphite into said mixture.

28. The process of claim 27, wherein said at least one metal powder comprises about eighty-nine percent (88%) of said mixture, said silicon powder comprises about ten percent (10%) of said mixture, said gas-producing blowing agent comprises about one percent (1%) of said mixture, and said graphite comprises about one percent (1%) of said mixture.

29. A foamed metal article produced by a process comprising the steps of:
combining together at least one metal powder, silicon powder and a gas-producing blowing agent including hydrated magnesium silicate powder to form a mixture;
compacting said mixture into a foamable metal precursor;
placing the foamable metal precursor in a mould; and,
heating the foamable metal precursor in said mould to at least a predetermined temperature for at least a predetermined amount of time, to thereby cause said foamable metal precursor to foam, thus producing a foamed metal article.

30. A foamable metal precursor produced by a process comprising the steps of:
combining together at least one metal powder, silicon powder and a gas-producing blowing agent including hydrated magnesium silicate powder to form a mixture; and,
compacting said mixture into a foamable metal precursor.
